(19) United States
(12) Patent Application Publication
(10) Pub. No.: US 2026/0003255 A1
(43) Pub. Date: Jan. 1, 2026

(54) PROJECTION DISPLAY

(71) Applicant: MARCEL SIELER, LEIPZIG (DE)

(72) Inventor: MARCEL SIELER, LEIPZIG (DE)

(21) Appl. No.: 18/836,760

(22) PCT Filed: Jan. 25, 2023
(86) PCT No.: PCT/DE2023/200019

§ 371 Date: Mar. 10, 2025

(30) Foreign Application Priority Data
Feb. 11, 2022 (DE) 10 2022 103 302.3
Jul. 1, 2022 (DE) 10 2022 116 516.7

(51) Int. Cl. G03B 21/00

(52) U.S. Cl. CPC G03B 21/008

(57) ABSTRACT

A projection display includes a light source, and at least one assembly. Each assembly has an optical element and at least two individual optical channels. Each of the optical channels are formed of a surface light modulator which influences a light propagation direction pixel by pixel. For all of the individual optical channels of the assembly, a cross-channel totality of optical elements of all individual optical channels illuminates the surface light modulator when light enters the assembly so that the optical element of the individual optical channel images a light which is reflected at the surface light modulator as an object structure and all images of the individual optical channels are superimposed to form one or more virtual or real overall images on a screen.

The invention relates to a projection display with at least one light source and regularly arranged optical channels. In particular, the invention relates to digital projection systems based on reflective pixelated surface light modulators (digital micro-mirror device, DMD)

It is known that the projection of static and dynamic image content onto a screen is realized using a slide projector or a projection display with one imaging channel or three imaging optical channels for color mixing or using laser scanners. The miniaturization required for use, e.g. as mobile imaging systems, regularly leads to a loss of brightness in the projected image.

Conceivable fields of application for the invention are therefore in the field of communication and entertainment electronics, data visualization, spectrometers, 3D printers and in the automotive sector, in particular for interior lighting and automotive exterior lighting, such as headlights.

Pico projectors with color-sequential LED illumination are known from US 2006/0285078 A1, but their miniaturization is only possible to a limited extent due to the limitation of the transferable luminous flux caused by the small surface area. This relationship is determined by the basic optical law of etendue conservation. Real optics increase the etendue or reduce the system transmission. This means that a minimum object area is also required for a minimum transmissible luminous flux within a projecting optical system. In the case of single-channel projection systems, due to optical laws (natural vignetting, imaging errors), the overall system length also increases to the same extent as the area to be imaged, which makes miniaturization more difficult. The novel approach of the array projector presented here overcomes this dependency between projection brightness and overall system length.

Scanning laser projectors represent an alternative concept for the radical miniaturization of projection systems. Here, as described in US20080265148, image content is generated by scanning a power-modulated laser beam across the image area. The brightness that can be achieved with this approach is primarily limited by the low power of available single-mode lasers and their limited modulation capability. Another significant disadvantage is the speckle structures in the projected image, which limit the achievable resolution.

DE 102009024894 A1 relates to a projection display with at least one light source and regularly arranged optical channels. The optical channels contain at least one field lens, to each of which an object structure to be imaged and at least one projection lens are assigned. The distance between the projection lenses and the assigned object structures corresponds to the focal length of the projection lenses, while the distance between the object structures to be imaged and the assigned field lens is selected in such a way that Köhler illumination of the assigned projection lens is possible. The individual projections are then superimposed to form the overall image.

DE 102010030138 A1 discloses a projection display (100) with at least one light source (110), at least one reflective image generator (120) which is designed to display individual images in a two-dimensional distribution (122) of partial areas (124) of the same, a projection optics arrangement (130) with a two-dimensional arrangement (132) of projection optics (134) which is configured to image an associated partial area (125) of the at least one image generator (120) onto an image plane (150) in each case, so that images of the individual images are superimposed in the image plane (150) to form an overall image (160), and at least one beam splitter (140) which is arranged in a beam path between the at least one reflective image sensor (120) and the two-dimensional arrangement (132) of projection optics (134), on the one hand, and the beam path between the at least one light source (110) and the at least one reflective image sensor (120), on the other hand.

A further projection display with an image sensor is described in DE 102011076083 A1, which is designed to generate individual images in a distribution, such as a two-dimensional distribution, of partial areas of an imaging plane of the image sensor, and a multi-channel optical system which is configured to image an associated individual image or an associated partial area of the image sensor per channel in each case, and in such a way that the image of the individual images is at least partially superimposed in a projection surface to form an overall image, the projection surface having a non-planar free-form surface, such as, for example, a curved surface, and/or is tilted relative to the imaging plane, and the image sensor is formed in such a way that constellations of points in the partial images, which are each superimposed by the multi-channel optics at a respective common point in the overall image, differ depending on the distance of the respective common point in the overall image from the multi-channel optics. Alternatively, the image sensor and multi-channel optics are formed in such a way that a characteristic of a contribution of each channel to the overall image varies locally across the overall image depending on the distance of the respective common point in the overall image from the multi-channel optics.

According to the solution from DE 102013208625 A1, it is possible to generate images to be projected at different projection distances with a multi-aperture projection display, namely statically or without any adjustment-neither mechanical nor on the image generator side—by suitably devising the individual images of the multi-aperture projection display, namely by combining preliminary individual images for the projection channels of the multi-aperture projection display, which are provided for each of the at least two images to be projected, projection channel by projection channel to form the actual or final individual images.

According to the current prior art, digital projection systems use a spatial light modulator (SLM), which makes it possible to modulate the light that strikes it in such a way that image-like information is generated and subsequently imaged by optical arrangements or directly directed onto a screen, as in the case of laser-scanning systems.

Each optical projection system is characterized by the luminous flux it can emit. The luminous flux of a single-channel projection system F_{EKP} is directly proportional to the square of the focal length of its projection lens (for a given slide area A, brightness of the light source B, system transmission T, f-number of the projection optics F and the paraxial focal length f_{EKP} of the projection optics):

$${Φ}_{E K P} = \frac{π A B T}{4 {F}^{2}} ∝ \frac{{f}_{E K P}^{2}}{{F}^{4}}$$

Multi-channel projection systems modelled on DE 102009024894 A1 circumvent this dependency by using a two-dimensional arrangement of projection channels. The luminous flux of such systems of multi-channel projectors F_{MKP} is calculated as follows:

$${Φ}_{M K P} = \frac{π A B T}{4 {F}^{2}} ∝ \frac{{f}_{M K P}^{2}}{{F}^{4}} \cdot N$$

with N as the number of all channels in the array and f_{MKP} as the paraxial focal length of an individual channel of the array. If we now compare a single-channel projector with a multi-channel projector with the same luminous flux, the result is the following relationship between the focal lengths:

$${f}_{M K P} = \frac{{f}_{E K P}}{\sqrt{N}}$$

For example, a multi-channel projector with 100 or 10*10 projection channels requires only a tenth of the focal length of a single-channel projector to transmit the same luminous flux. This creates enormous potential for saving installation space, as the overall length of a projector correlates directly with its focal length.

The object of the invention is to propose a digital projection display which provides a combination, which has not yet been realized, of luminous intensity, compactness and efficiency with a minimum number of necessary components.

This object is achieved by the projection display having the features of claim 1. The further dependent claims present advantageous embodiments.

The present invention describes the technical solution for transferring the array projection principle to DMD (digital micro-mirror device) for modulating the light to be imaged.

This technology is often referred to as DLP (brand name of Texas Instruments).

DMDs modulate the incoming light by controlled deflection using a two-dimensional matrix arrangement of reflective pixel surfaces, which can change their tilt angle between two states at high frequency individually by electrical control. These two defined states are subsequently referred to as ON and OFF.

If the light hitting the DMD and subsequently reflected by the micromirrors passes the projection lens assigned to the DMD in the direction of the screen and is optically imaged by the optical refractive power of the projection lens, this is referred to as the ON state of those pixelated tilted mirror surfaces.

In the tilted mirror OFF state, light beams are not directed towards the assigned projection lens, but are usually fed to a beam trap. This means that they do not serve for the projection image and do not reach the screen. Pixels of a DMD in the de-energized state (FLAT state) deflect the light in an uncontrolled manner into an intermediate angle range between the ON and OFF deflection direction, typically also into a beam trap. [https://www.ti.com]

The advantages of a DMD over other surface light modulator technologies such as LCD or LCoS lie in its inherently high transmission due to reflection instead of absorption, its modulation capability even when using unpolarized light and the ability to modulate light over a wide spectral range from UV, through VIS, to IR. According to the current prior art, DMDs with pixels only 5.4*10⁻⁶ m apart and a total pixel count of 1920×1080 pixels are commercially available.

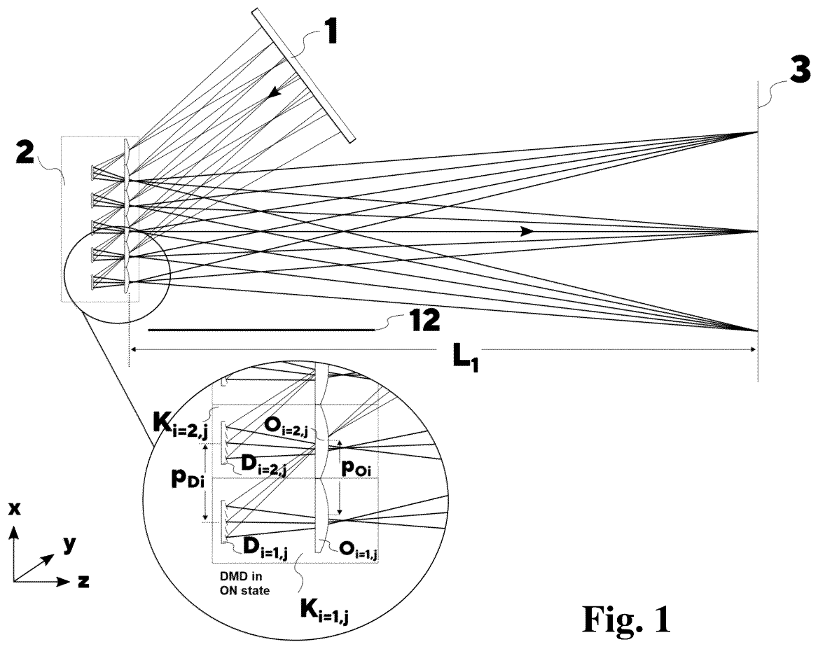

In the following, the solution according to the invention will be explained in greater detail using exemplary embodiments and FIGS. 1 to 19.

FIG. 1 shows an example of the projection display according to the invention, by way of example in a y-sectional view, which generates a real overall image on a screen 3.

The light emitted by a light source 1 strikes an assembly 2 2,
consisting of optical channels K,
formed in a two-dimensional i×j matrix lying in the x-y plane, with i∈{1,2,3,4,5,6}
and j∈{1,2,3}, consisting of individual optical channels with center-to-center distances p_{Oi} in the x-direction and p_{Oj} in the y-direction as their matrix elements K_{i,j},
each defined by:

K_{i,j}=(D_{i,j},O_{i,j}) with i,j∈ [symbol] and j∈{1,2,3} and i∈{1,2,3,4,5}

K_{i,j}=(O_{i,j}) with i,j∈ [symbol] and j∈{1,2,3} and i=6
with a surface light modulator D_{i,j}, which can address the direction of light propagation pixel by pixel by reflection and of which the normal vector of light incidence and light emission vectors runs parallel to the y-axis after reflection, arranged in 5 rows and jₘₐₓ columns, and an optical element O_{i,j}, arranged in 6 rows and jₘₐₓ columns,
wherein the respective individual optical channel K_{i,j} is formed in such a way,
that when light enters the assembly 2, the surface light modulators D_{i,j} of the individual channel K_{i,j} of the i-th row and the j-th column are illuminated by a subset of the optical elements (O_{i,j}) that are identical to each other and are defined by the illumination assignment function b(i,j) according to

$$b ( i , j ) ⊂ \{ {O}_{i , j} , {O}_{( i + 1 ) , j} , {O}_{( i + 2 ) , j} \} with b ( i , j ) \neq \{ {O}_{i , j} \} and b ( i , j ) \neq ∅$$

and, respectively,

$$b ( i , j ) = \{ \{ {O}_{i , j} , {O}_{( i + 1 ) , j} \} , \{ {O}_{i , j} , {O}_{( i + 2 ) , j} \} , \{ {O}_{i , j} , {O}_{( i + 1 ) , j} , {O}_{( i + 2 ) , j} \} , \{ {O}_{( i + 1 ) , j} \} , \{ {O}_{( i + 1 ) , j} , {O}_{( i + 2 ) , j} \} , \{ {O}_{( i + 2 ) , j} \} \}$$

with a counting method for i in which the (i+1)-th channel row is always positioned between the i-th channel row and the light source. Channel rows have a decreasing distance to the light source 1 as the row index i increases,
so that, after reflection, at the surface light modulator D_{i,j} of the i-th row and j-th column, each of the surface light modulators D_{i,j} is optically imaged by the set of optical elements O_{i,j} of the i-th row and j-th column defined by the projection mapping function p(i,j) according to

$$p ( i , j ) = \{ {O}_{i , j} \}$$

and all individual projection images of the assembly 2 are superimposed to form one or more virtual or real overall images on a screen 3. Individual channels with the same i-index are referred to below as rows, and channels with the same j-index are referred to below as columns. Counting of i and j is performed in ascending order in the positive x and y directions, starting with the index 1.

A surface light emitter of the channel of the i-th row and j-th column is therefore illuminated by a combination of itself and its channel row neighbors lying in the direction of the light source, which is permissible according to the above subset description b(i,j), and is imaged or projected by its optical element assigned in the same channel after reflection at the surface light modulator.

The optical elements O_{6,j} do not have a projecting function in the exemplary arrangement, but only serve to illuminate the last row of surface light modulators D_{5,j} of the array. The channels K_{6,j} are therefore a special case and, unlike all other channels, do not have a dual function as illumination and projection channels, but are therefore only illumination channels.

In the flat state of a mirror pixel of the surface light modulator, the mirror surfaces are orientated in a plane parallel to the x-y plane. To achieve the ON state of all pixels of the individual surface light modulators D_{i,j}, they are rotated around an axis formed by their surface center and the y-unit vector of the system by the angle α_{DMD}, specifically in such a way that the normal vector of the reflecting pixel surfaces, which in the FLAT state pointed in the direction of the z-axis, is now tilted in the direction of the light source.

All optical elements O_{i,j} are identical to each other in the exemplary arrangement shown. Neighboring channels in the x-direction are denoted by O_{i,j} and O_{(i+1),j}.

The (i+1)j-th optical element O₍ᵢ₊₁₎ⱼ is embodied here in such a way that the light beam which reaches it from the light source 1 illuminates the i,j-th surface light modulator D_{i,j}, and the optical element O_{i,j}, which is identical to the optical element of its neighboring channel O_{i+1,j}, images the surface light modulator D to form a real individual image on a screen, and the entirety of the individual images of all individual channels K_{i,j} are completely superimposed to form an overall image on a screen 3 at a distance L₁.

For large projection distances, the distance of the optical element O_{i,j} in the z direction to its corresponding surface light modulator D_{i,j} corresponds approximately to the paraxial focal length f_{MKP} of the optical element of the single projection channel according to the imaging equation of geometric optics.

The main rays of the light beams effective for the imaging are shown.

The system is configured in such a way that only light beams from the respective (i+1)-th neighboring channel K_{i+1,j} relative to the i-th channel K_{i,j} hit the surface light modulator D_{i,j}, i.e. in the i-th channel row, in such a way that the reflected light can effectively pass through the optical element O_{i,j} corresponding to this surface light modulator with row index i as a projection lens and is projected onto a screen by it in a focused manner.

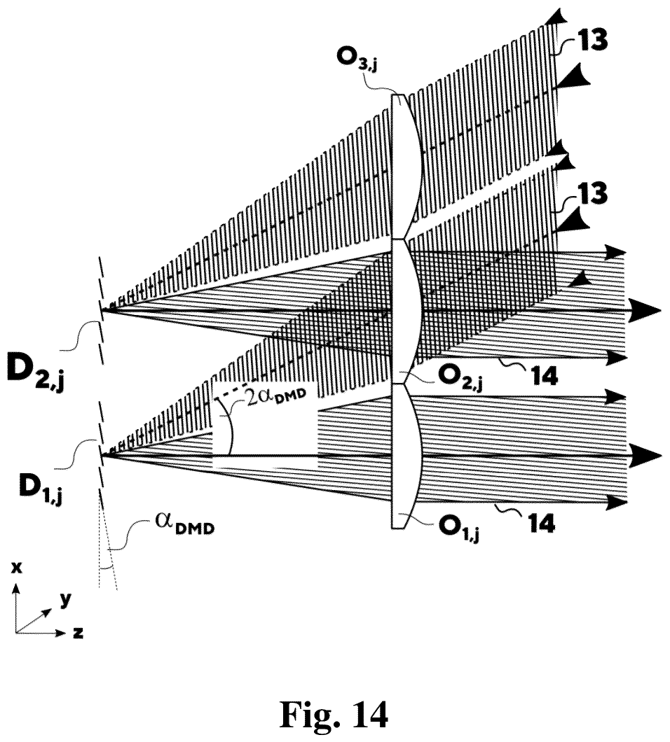

For optimum, telecentric illumination of the i-th optical element, the angle of incidence of the main beam of the light bundle, which hits the center of the surface light modulator D_{i,j}, coming from the (i+1)-th optical element, should preferably be twice the maximum deflection angle of the tilting mirror α_{dmd} (see FIG. 14).

The optical axes of the individual projections of all individual channels K_{i,j} have a convergence to each other due to a defined center-to-center distance between neighboring optical elements p_{Oi} and pₒⱼ and neighboring surface light modulators p_{di} and p_{dj}, which ensures that all individual images on a screen 3 are completely superimposed to form an overall image at a distance L₁.

The following applies:

$${L}_{1} = \frac{{f}_{M K P} \cdot {p}_{Oi}}{( {p}_{Di} - {p}_{Oi} )} = \frac{{f}_{M K P} \cdot {p}_{Oj}}{( {p}_{D j} - {p}_{Oj} )}$$

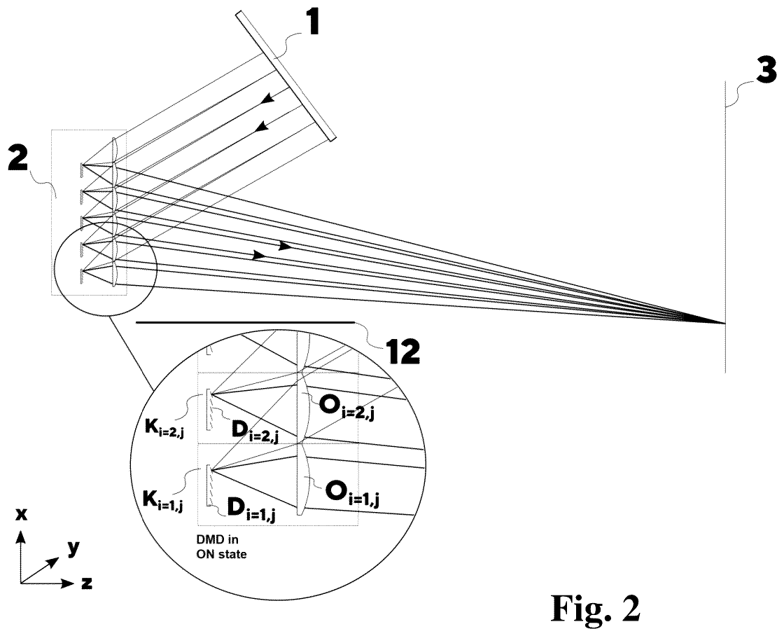

FIG. 2 shows the arrangement from FIG. 1 and, instead of the main beams, the full light beams for the lowest pixel of the overall image in the x-direction.

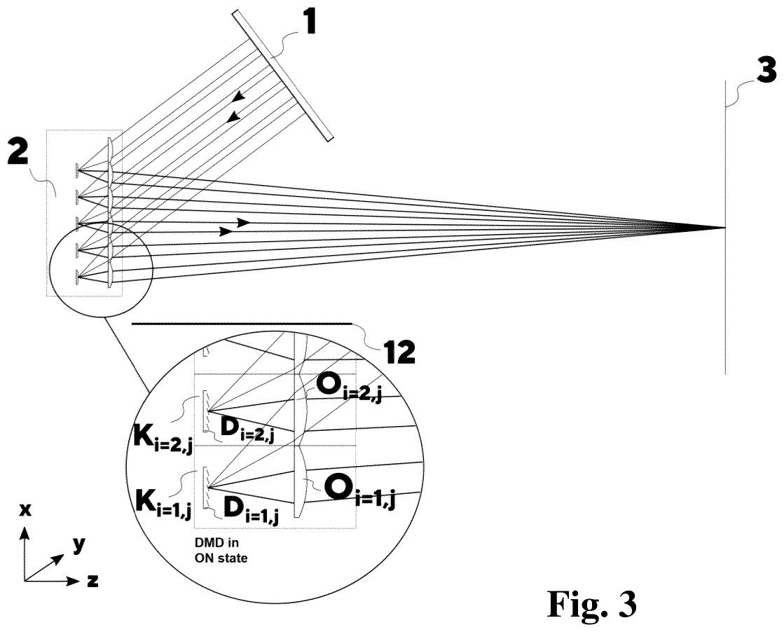

FIG. 3 shows the arrangement from FIG. 1 and, instead of the main beams, the full light beams for the center of the overall image in the x-direction.

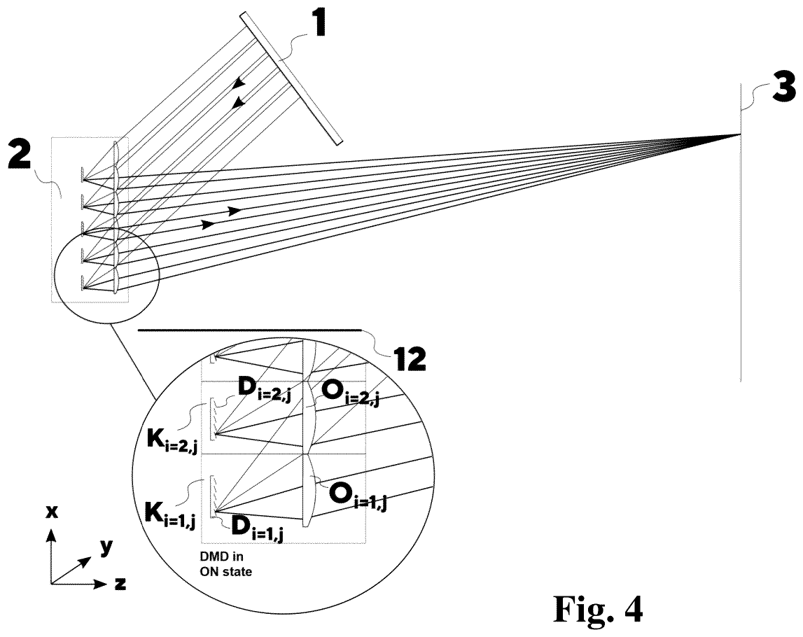

FIG. 4 shows the arrangement from FIG. 1 and, instead of the main beams, the full light beams for the uppermost pixel of the overall image in the x-direction.

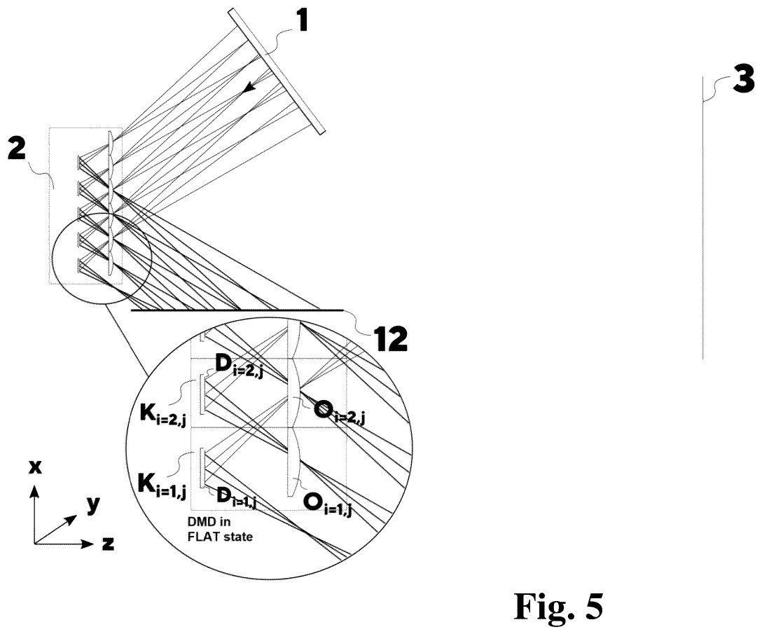

FIG. 5 shows the arrangement from FIG. 1 and, instead of the ON state of all individual pixels of the surface light modulator (as shown in FIG. 1-4), the normal vectors of the individual mirrors are now oriented along the z-axis. In DMDs, this is usually referred to as the FLAT state. In this pixel state, the arrangement ensures that the light beams that hit the reflective surface light modulators are not imaged onto the screen 3 and end up in a beam trap 12.

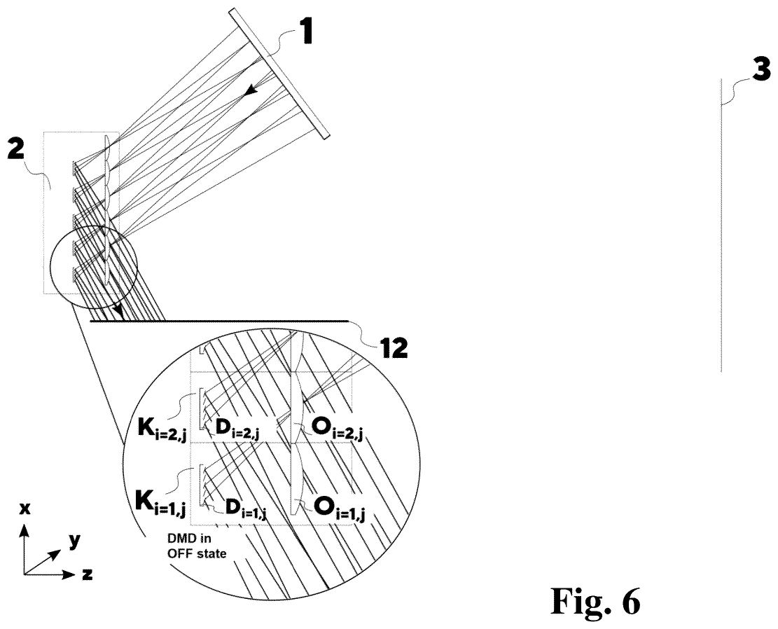

FIG. 6 shows the arrangement from FIG. 1, where, instead of the previous orientation of the tilting mirrors in the ON state (FIG. 1-4), the individual mirror surfaces are now rotated clockwise from the light source by the angle 2α_{DMD} around the axis defined by the pixel surface center and the y unit vector of the system. This denotes the OFF state of the individual pixels of the surface light emitter.

All light beams that hit OFF pixels are deflected downwards even more than in the flat state (see FIG. 5) and do not contribute to the imaging on the screen. To minimize scattered light, they are directed into a beam trap 12.

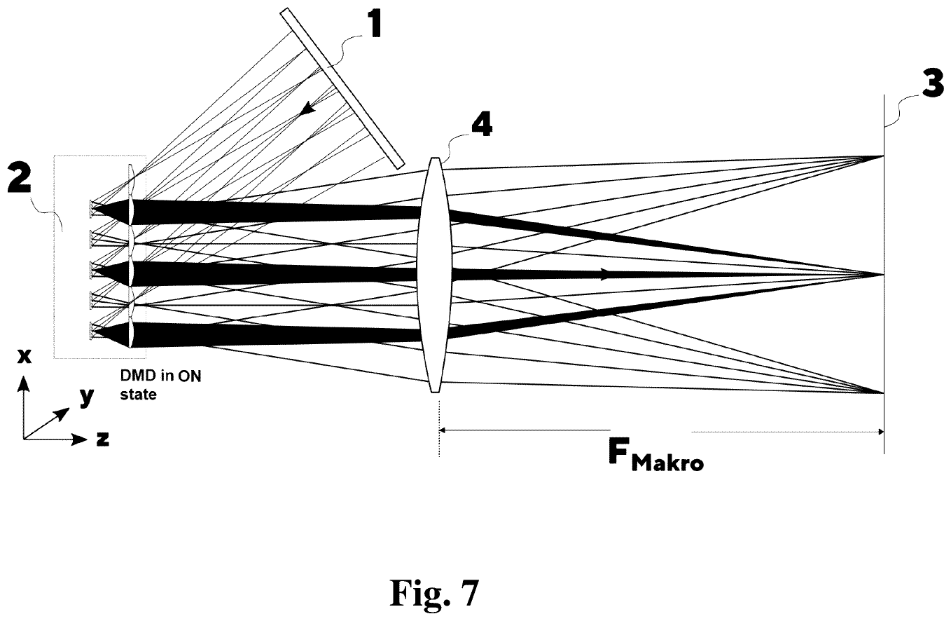

FIG. 7 shows the arrangement according to the invention as shown in FIG. 1 with five individual projections without convergence to each other. The individual channel projections are first imaged to form an overall image on the screen 3 with the aid of an upstream biconvex overall lens 4 (converging lens) with a fixed positive focal length F_{Makro} at a distance F_{Makro} and combined by complete superimposition.

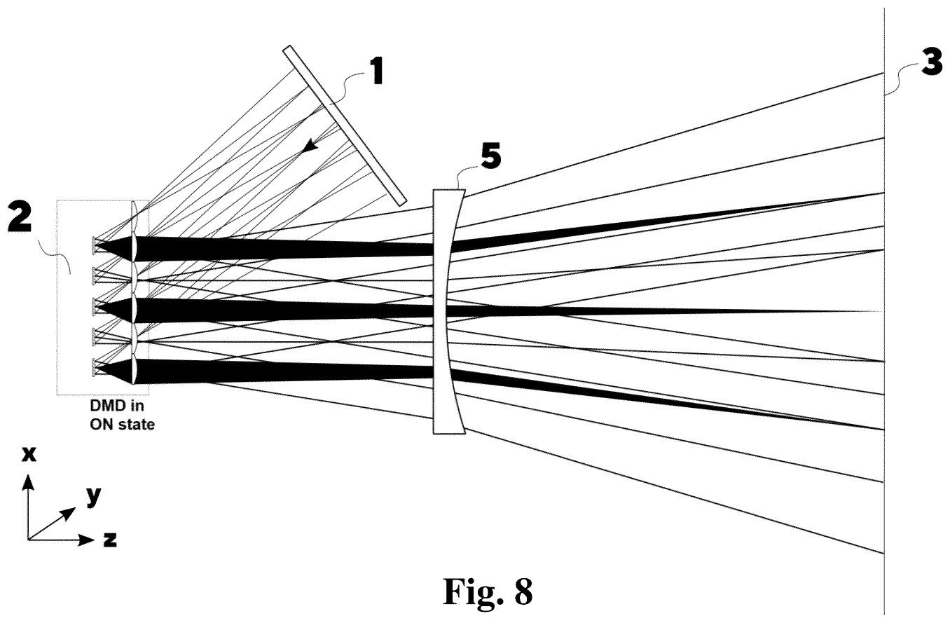

FIG. 8 shows the arrangement according to the invention as shown in FIG. 1 with individual projection images which leave the assembly 2 without convergence, i.e. parallel to each other. The individual projection images impinge on an overall lens 5 with a variably adjustable focal length. This aligns the optical axes of the individual projections according to their set focal length (a negative focal length is shown in the figure), so that the individual projection images can be aligned convergent, parallel or divergent to each other in the direction of a screen 3. This adjustable focal length enables variable image synthesis in order to be able to switch dynamically between different overall images with maximum illumination and minimum number of pixels and minimum image size or an overall image with maximum number of pixels and minimum illumination and maximum image size.

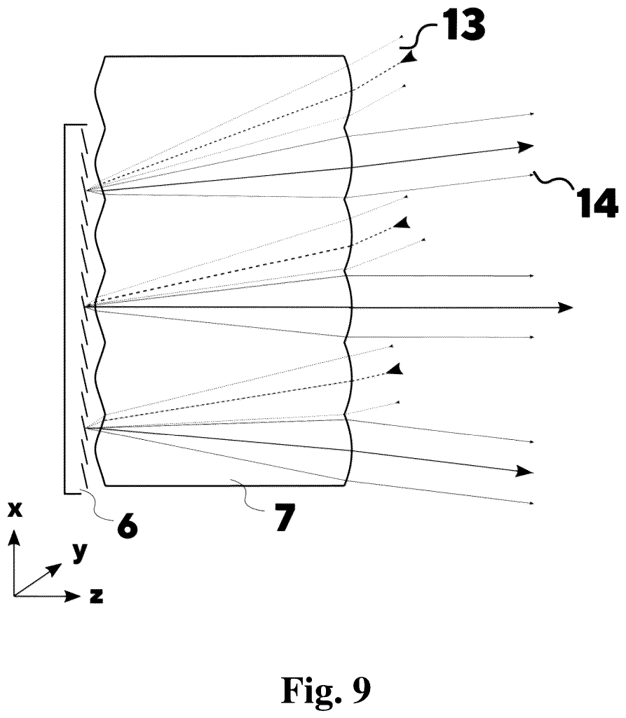

FIG. 9 shows the arrangement according to the invention realized by combining the individual surface light modulators D_{i,j} in the form of a large-area composite surface light modulator 6. The individual optical elements are embodied as a monolithic component in the form of a lens array 7, consisting of two optical surfaces per individual channel. The optical surface facing the surface light modulator 6 is a free-form surface and the surface facing the screen is an aspherical surface. The effective light beams are shown both in the illumination beam path 13 and in the projection beam path 14 (after reflection at the DMD) for three different pixels. The light for illuminating the i-th surface light modulator comes entirely from the neighboring channel with row index i+1 directly adjacent in the y-direction.

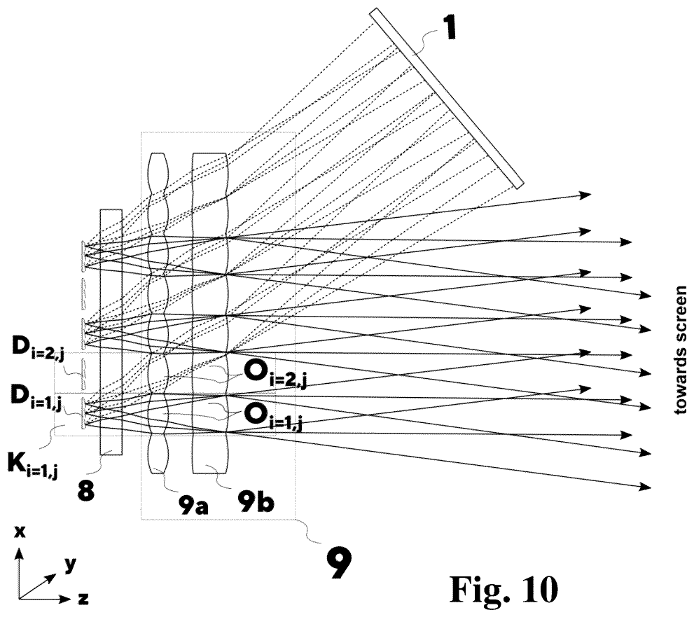

FIG. 10 shows a specific embodiment of the invention. This is an arrangement of surface light modulators D_{i,j} with 5 rows and j columns, equipped with a cover plate 8 positioned in front of it in the projection direction. The optical elements O_{i,j} of the individual channels, arranged in 6 rows and j columns, are each formed from two lenses, each with two optical surfaces. The optical system 9 is formed from two double-sided monolithic lens arrays, wherein the first lens array 9a contains a two-dimensional arrangement of the first lens from the optical element O_{i,j} and the second lens array 9b contains a two-dimensional arrangement of the second lens from the optical element O_{i,j}.

The surface light modulator D_{i,j} is illuminated by both the optical element O₍ᵢ₊₁₎ⱼ and O₍ᵢ₊₂₎ⱼ. The surface light modulator D_{i,j} is projected by the optical element O_{i,j} for each channel row with i∈{1, . . . , 5}. The main beam paths for the projections from the channel rows are shown with i∈{1,3,5}.

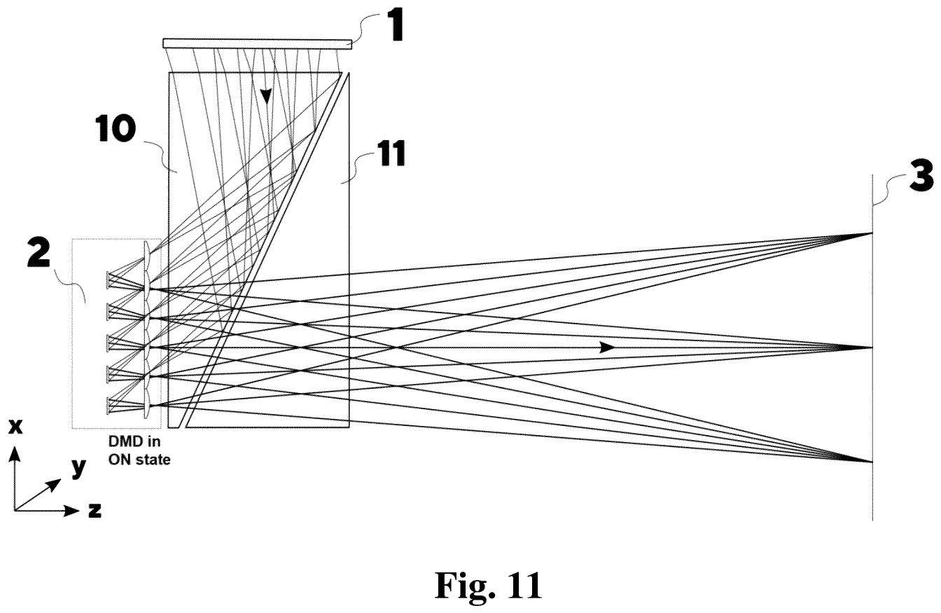

FIG. 11 shows the arrangement according to the invention, wherein the illumination beam path 13 and the projection beam path 14 of the individual channels are separated here with the aid of a monolithic prism 10. The light beams coming from the light source 1 of the illumination are totally reflected at a side surface of the prism 10 (TIR prism) due to their flat angle of incidence and then reach the assembly 2 under oblique incidence. Due to the reflective deflection and angular change of the light beams at the surface light modulators D_{i,j}, each light beam, which is imaged by the respective optical element O_{i,j} to form an individual projection image, can be transmitted in the direction of the screen 3 through the prism 10 and through a second prism 11, which compensates for the refractive angular deflection of the prism 10. Compared to the arrangement in FIG. 1, this enables an even more compact design, as the beam paths, even if they are not yet spatially separated from each other, can be directed in different directions by total internal reflection, i.e. depending on the angle, and are thus spatially separated within a minimal installation space. All individual projection images are completely superimposed to form an overall image on the screen 3.

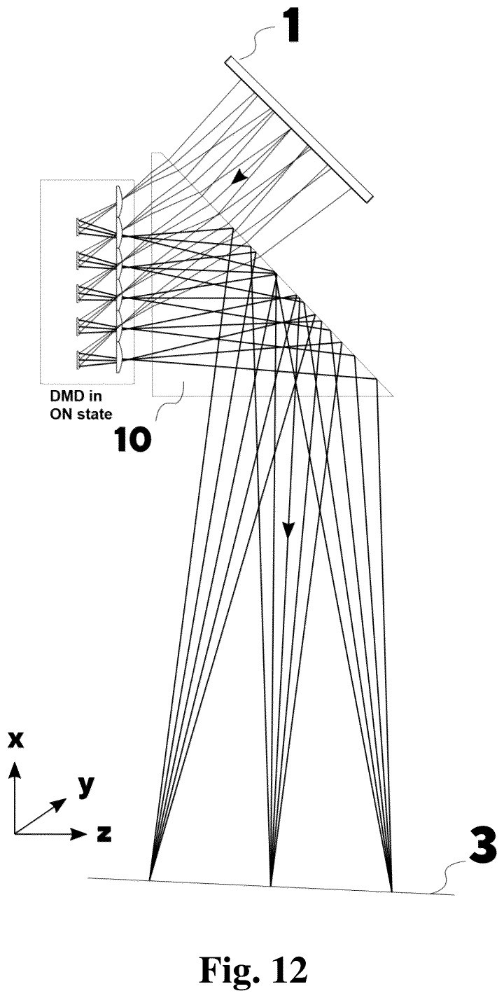

FIG. 12 shows the invention, wherein the beams of illumination, in contrast to FIG. 11, pass through a prism 10 in a refractive manner and reach the assembly 2 without total reflection. Due to the reflective angular deflection at the surface light modulators D_{i,j} and the following imaging by the optical elements O_{i,j}, the light beams in the projection beam path are totally reflected at a boundary surface of the prism 10 and thus deflected in the direction of the screen. As in FIG. 11, the utilization of total internal reflection as an angular filter enables a further reduction in the size of the overall system compared to the arrangement in FIG. 1.

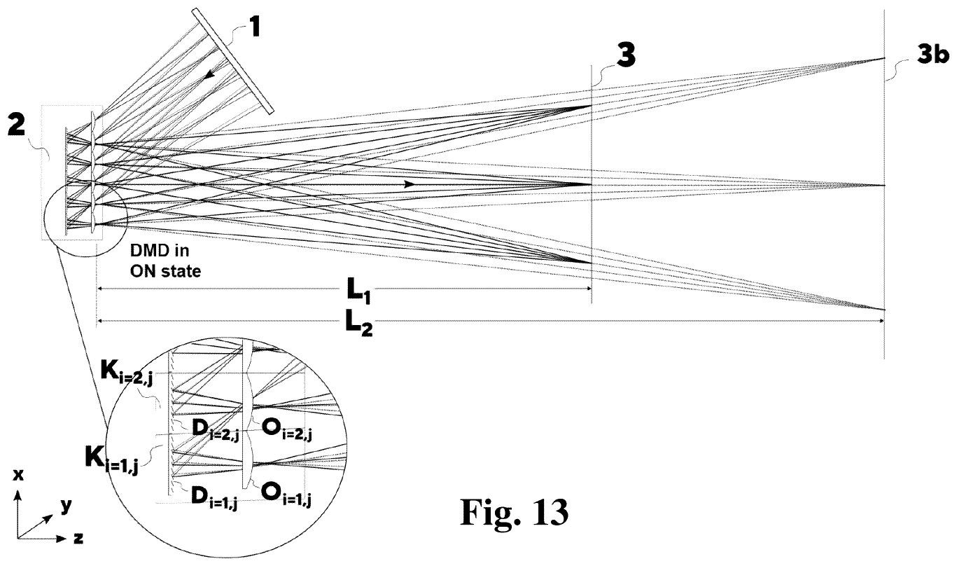

FIG. 13 shows the invention in two different states. State 1 corresponds to a projection of a real overall image at a projection distance L₁ from the assembly 2 and state 2 (dashed lines) shows the projection of a real overall image at a second projection distance L₂, wherein L₁<L₂.

The increase in the projection distance results from a reduced convergence of the individual projection images in relation to each other, which is generated by reducing the center-to-center distance between neighboring single-surface light modulators. Due to the electrical controllability of the image contents of the individual surface light modulators, an effective change in the PDI can be realized preferably without mechanical displacement of the D_{i,j} itself, but rather simply by displacing the image information on the D_{i,j} relative to each other, and thus different distances can be generated for the synthesis of an overall image.

FIG. 14 shows an example of the invention using a composite of 3 channels consisting of K_{1,j}=(D_{1,j}, O_{1,j}) and K_{2,j}=(D_{2,j},O_{2,j}) and K_{3,j}=(O_{3,j}). The angle of incidence of the main beam on the surface light modulator is 2α_{DMD} in order to produce telecentric illumination of the optical element at a tilt angle of α_{DMD}.

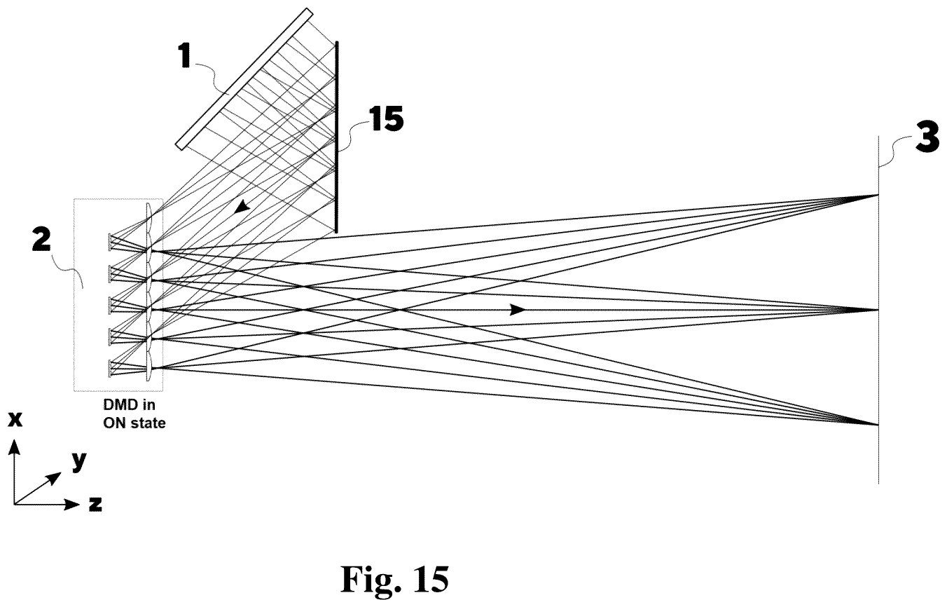

FIG. 15 shows the arrangement according to the invention from FIG. 1, supplemented by a reflector 15 in the illumination beam path. This serves to further miniaturize the arrangement.

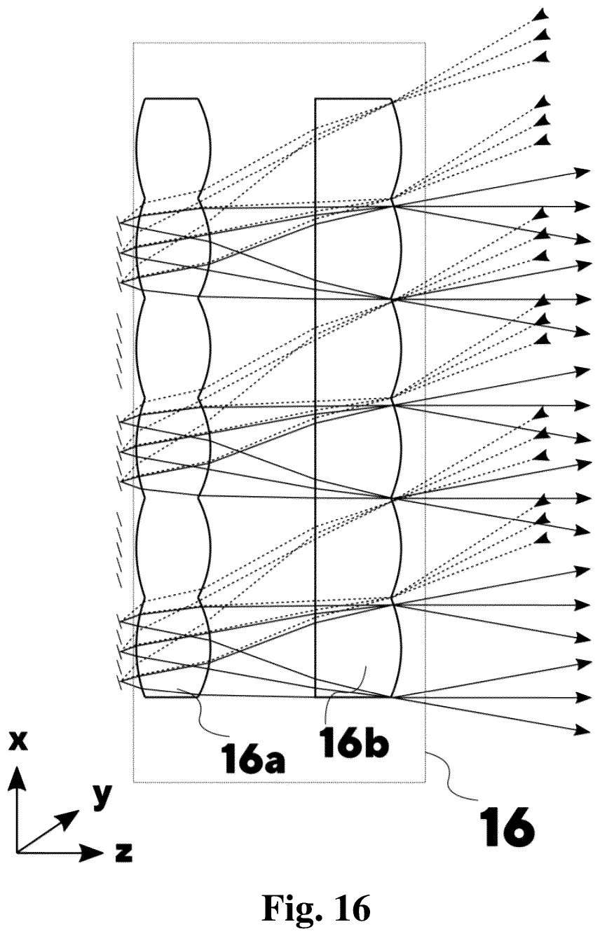

FIG. 16 shows a specific embodiment of the invention. It is an arrangement of surface light modulators D_{i,j} with 5 rows and 3 columns. The optical elements O_{i,j} of the individual channels, arranged in 6 rows and 3 columns, are each formed from two lenses, each with two optical surfaces. The optical system 16 is formed from two double-sided monolithic lens arrays, wherein the first lens array 16a contains a two-dimensional arrangement of the first lens from the optical element O_{i,j} and the second lens array 16b contains a two-dimensional arrangement of the second lens from the optical element O_{i,j}.

In contrast to FIG. 10, the individual surface light modulator D_{i,j} is illuminated by the optical element O_{i,j} as well as O₍ᵢ₊₁₎ⱼ, i.e. the direct neighbor and a subset of the optical elements of its own channel. There is no cover plate 8 in this arrangement. The surface light modulator D_{i,j} is projected by the optical element O_{i,j} for each channel row with i∈{1,2,3,4,5}. The main beam paths for the projections from the channel rows are shown with i∈{1,3,5}.

FIG. 16a shows the spatial and angular distribution of the light source 1 from the arrangement in FIG. 16. The light source has a rectangular shape with a larger extent in the x-direction and a square angular distribution with divergence angles of approx. ±5° in the x- and y-directions.

FIG. 16b shows the spatial and angular space distribution recorded in the plane of the screen-facing entry surfaces of the optical elements O_{i,j}. The light from the light source strikes the optical elements O_{i,j} at the main beam angle of approximately −24°, which corresponds to twice the tilting mirror angle of the DMD α_{DMD} with i∈{2,3,4,5,6} and j∈{1,2,3}.

FIG. 16c shows the spatial and angular distribution recorded in the plane of the surface light modulators D_{i,j}. Each of the 5×3 illuminated optical elements generates an image of this distribution on the DMDs channel by channel from the angular distribution of the light source. The main beam angle of the light beams for the center of the image is +24° in the x-direction. Tilting mirrors in the ON state deflect this main beam angle to 0°, i.e. in the z direction, through the optical element corresponding to D_{i,j} in the screen direction. Tilting mirrors in the flat state deflect the main beam angle to x−24° and pixels in the OFF state deflect the main beam to −48°.

FIG. 16d shows the arrangement from FIG. 16 in a 3-dimensional view. The beam path of three main beams coming from the light source 1 is shown for the imaging of the centers of the surface light modulators D₃ⱼ with j∈{1,2,3}. The following beam paths are shown as examples:
O₄₁ illuminates D₃₁ and is projected by O₃₁ in the direction of the screen.
O₄₂ illuminates D₃₂ and is projected by O₃₂ in the direction of the screen.
O₄₃ illuminates D₃₃ and is projected by O₃₃ in the direction of the screen.

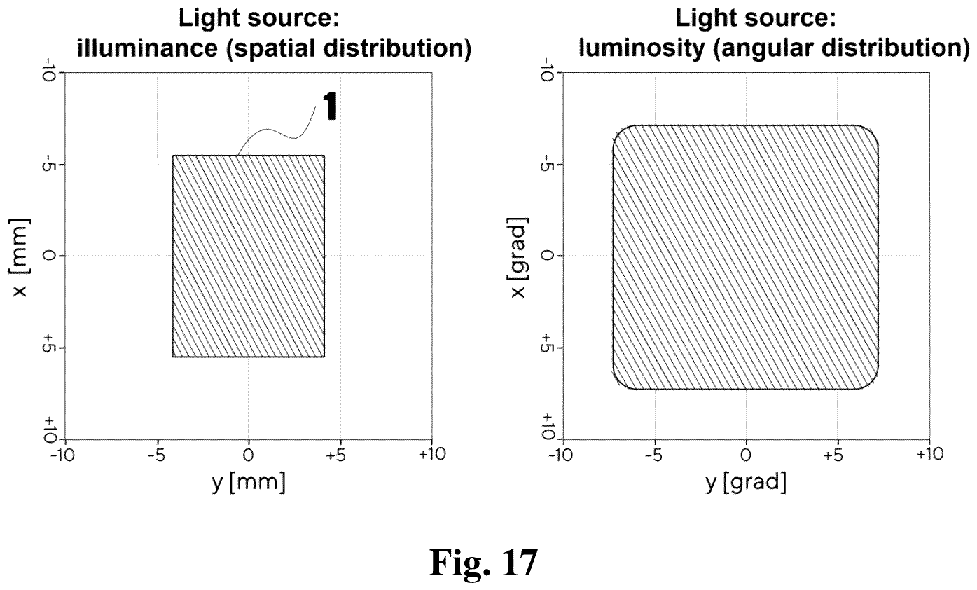

FIG. 17 shows, in a particular embodiment of the solution according to the invention, the combination of two projection displays according to the invention PDₐ and PD_{b}, PDₐ consisting of the light source 1a and the assembly 2a, and PD, consisting of the light source 1b and the assembly 2b.

The light source 1a is formed in such a way that only the half of each surface light modulator D_{ai,j} that is further away from the light source in x-orientation (shown as an example for the surface light modulators D_{a1,j} with the lower image half 18_{a1,j}) is illuminated. The projection display PD_{b} corresponds to the projection display PDₐ, mirrored on the y-z plane shifted to the center of the surface light modulators D_{ai,j}. All pixels of all surface light modulators are initially in the FLAT state. All surface light modulators of the projection display PDₐ are utilized by the projection display PD_{b}, just as the optical elements of the rows O_{ai,j} with i∈{1,2,3,4,5} are also utilised. The following therefore applies to the designation of the optical elements O_{a1,j}≡O_{b5,j} and O_{a2,j}≡O_{b4,j} and O_{a3,j}≡O_{b3,j} and O_{a4,j}≡O_{b2,j} und O_{a5,j}≡O_{b1,j} and for the surface light modulators D_{a1,j}≡D_{b5,j} and D_{a2,j}≡D_{b4,j} and D_{a3,j}≡D_{b3,j} and D_{a4,j}≡D_{b2,j} and D_{a5,j}≡D_{b1,j}.

If the image content of the channel-specific upper image half 17_{ai,j} (shown as an example with 17_{a1,j} for the channel (K_{a1,j})) of all surface light modulators is now inverted, these image contents act on the projection displays PD, or when the light source 1b is projected onto 2b as if the pixels of the upper halves of the surface light modulators were not inverted and are accordingly imaged by the optical elements O_{ai,j} with i∈{1, . . . , 5} in the direction of the screen 3. The combination of all channels can therefore project an overall image with correct distribution of illuminated and non-illuminated surfaces through the interaction of all optical elements and both light sources with correct modulation of the tilted mirror states.

The advantage of this arrangement of two combined projection displays PDₐ and PD_{b} is constituted by the lower technical requirements for the optical elements of each channel, as these now have to illuminate a significantly smaller area of each neighboring channel or have to be able to image within the channel itself. To avoid false light in the projection image, it is advantageous to ensure the sharpest possible separation and a clean connection of the illumination areas on the surface light modulators between the illumination areas coming from 1a and 1b.

FIG. 17a shows the arrangement from FIG. 17 in the z-view, illuminated by the light source 1a. All 5×3 surface light modulators are shown, wherein only the lower half of each is illuminated by 1a. The surface elements effective as ON pixels for the light source 1a are hatched; the surface elements effective as OFF pixels are shown in black.

FIG. 17b shows the arrangement from FIG. 17 in the z-view, illuminated by the light source 1b. All 5×3 surface light modulators are shown, wherein only the upper half of each is illuminated by 1b. The surface elements that are effective as ON pixels for the light source 1b are hatched, while the surface elements that are effective as OFF pixels are shown in black.

FIG. 17c shows the merged projection image of all images of all lower image halves 18ai.j by PDₐ and all images of all upper image halves 17_{ai,j} by PD_{b} on the screen 3, consisting of a dark “F” in the center of a brightly illuminated square.

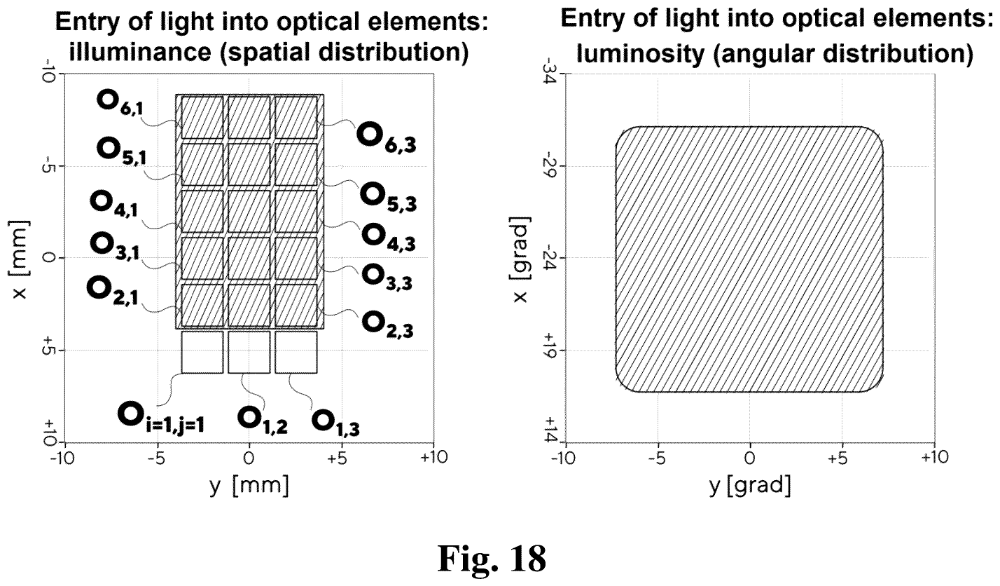

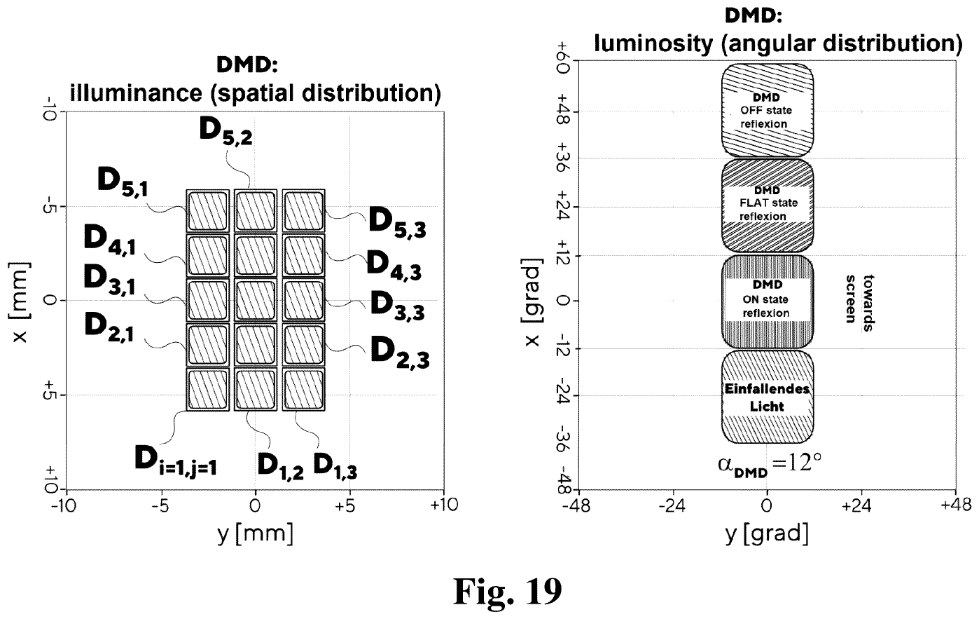

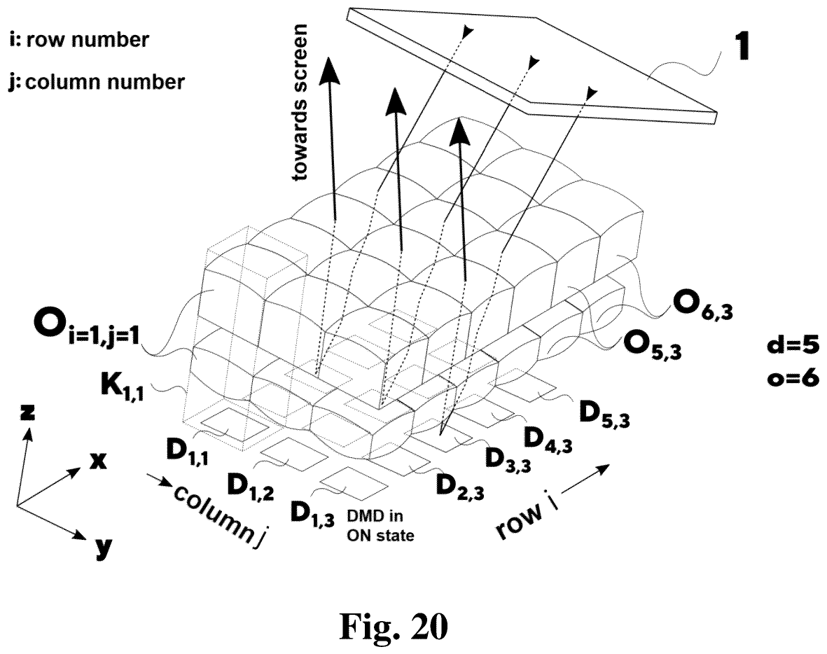

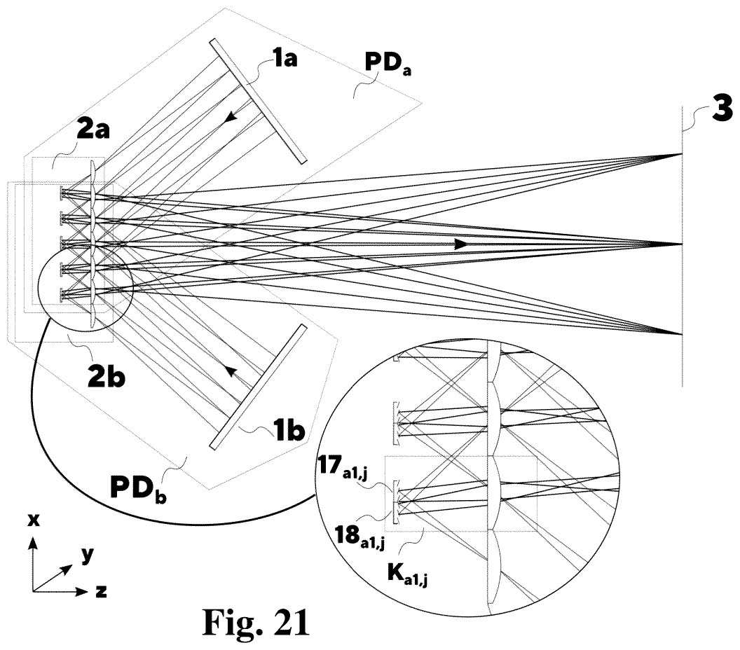

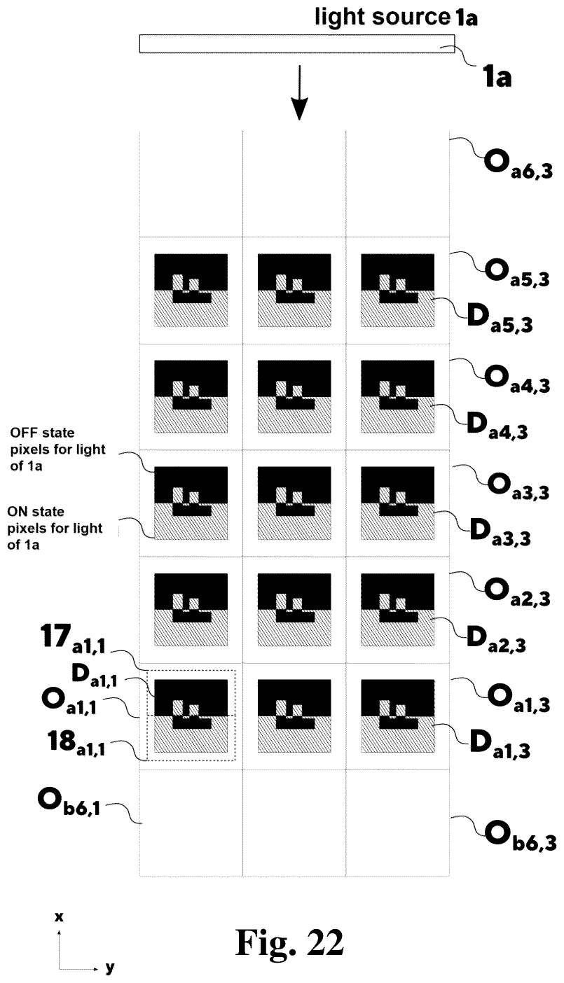

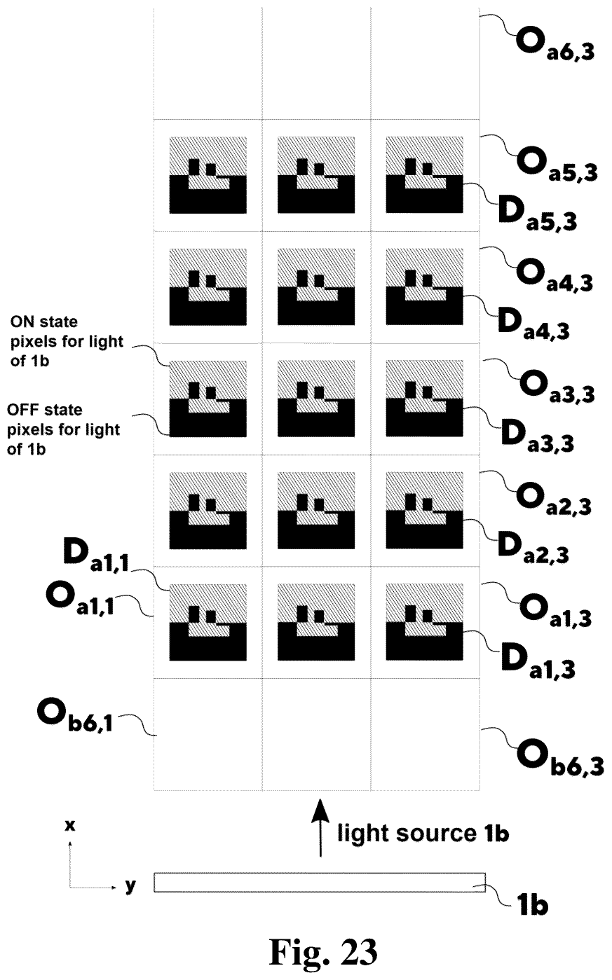

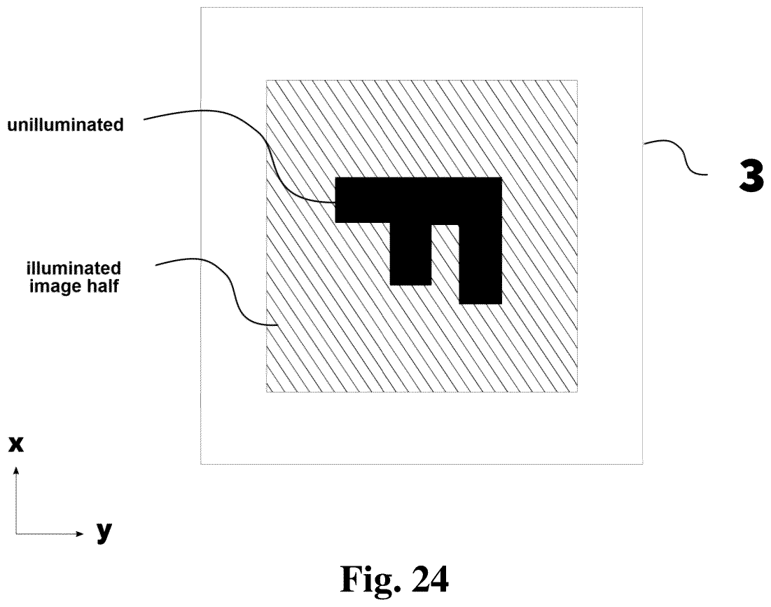

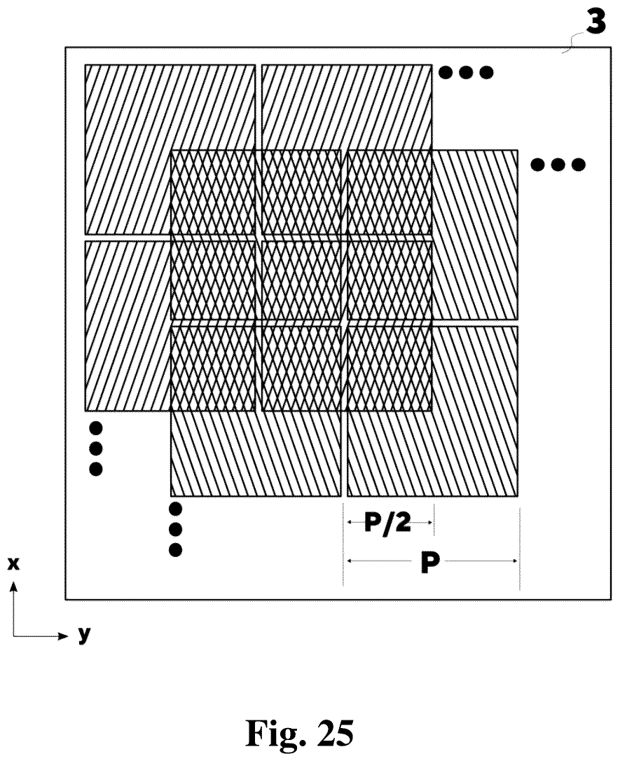

FIG. 18 shows the exemplary superimposition of two individual projection images on the screen 3, wherein these are each shifted by P/2 in the x-direction and y-direction, with P as the center-to-center distance of the projected pixels of a surface light modulator D_{i,j} of an assembly 2. This enables a doubling of the number of displayable modulable image pixels both in the x-direction and in the y-direction, i.e. a quadrupling of the total pixels that can be displayed.

In each case, 2×2 projection pixels are shown from the total quantity of all projection pixels of a single projection image of usually several hundred pixels in x and y orientation. This form of half-pixel overlay can be generated by adjusting the spatial offset of a subset of the individual projectors. This can be generated, for example, by decentering a subset of all optical elements relative to a second subset of all optical elements. This effect, usually referred to as lens shift, around a half-pixel extent on the image side in x and y orientation, can be realized both by decentring a subset of optical elements and by decentering a subset of surface light modulators with respect to a regularly arranged array of optical elements with the same center-to-center distance to each other. In contrast to conventional single-channel projection systems, which usually use high-frequency mechanics to realize this half-pixel overlay in a time-sequential manner, a multi-channel projection system formed in this way can generate the increase in displayable image information (super-resolution) without moving parts (solid-state).

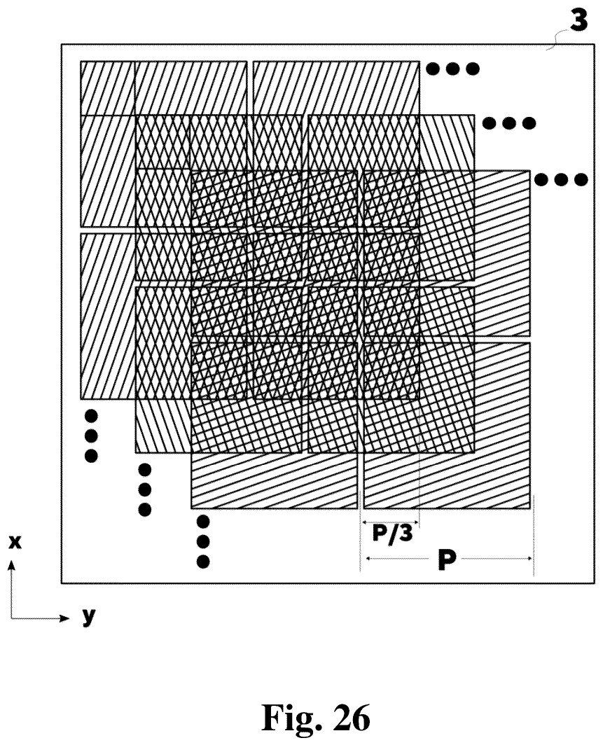

FIG. 19 shows the exemplary superimposition of three individual projection images on the screen 3, wherein these are each shifted by P/3 in the x-direction and y-direction, with P as the center-to-center distance of the projected pixels of a surface light modulator D_{i,j} of an assembly 2. This enables a tripling of the displayable modulable number of image pixels both in the x-direction and in the y-direction, i.e. a ninefold increase in the total pixels that can be displayed (super-resolution). In contrast to FIG. 18, this requires three subsets of channels K_{i,j}, the optical axes of which are deflected either by ⅓ pixel shift or ⅔ pixel shift in angular space to a first subset of optical channels. A deflection can be achieved, for example, by decentering a subset of all optical elements with respect to the entirety of surface light modulators with a uniform center-to-center distance to each other or by decentering a subset of surface light modulators with respect to the entirety of optical elements with the same center-to-center distance to each other.

In a particular embodiment of the solution according to the invention, the paraxial focal length of the optically effective elements is preferably 0.5 mm-30 mm.

An advantage of the solution according to the invention is that, due to the superimposition of a large number of surface light modulators on the screen 3, which are provided with a channel-individual spatial lighting distribution, not only is the image information superimposed on the screen, but all channel-individual spatial lighting distributions on the D_{i,j} are also superimposed on the screen 3. Compared to conventional single-channel projection systems, this inherent arrangement-related mixing of the light distributions ensures better uniformity of the light distribution over the entire image.

A conventional single-channel projection system, which requires a comparable homogeneity of illumination of the overall image, therefore always requires more effort, e.g. due to a higher number of optical elements in the structure within the illumination beam path.

Due to the fact that, compared to a conventional projection system with the same luminous flux (depending on the number of channels N), the focal length of the optical elements required for imaging is significantly reduced approximately to 1/\sqrt{N}, there is a significant potential for saving installation space by utilising the proposed multi-channel projection principle using the reflective surface light modulators described.

The dual function of the optical elements of each channel, i.e. their utilization for both the illumination and the projection function, results in an enormous component savings potential compared to conventional projection systems. Due to the resulting lower complexity and reduced tolerance chain, this can lead to projection systems that are significantly more powerful, less susceptible to faults and more cost-effective.

The application of the method described in DE 102011076083 A1 to the proposed solution according to the invention enables the projection of high-contrast, bright projection images on, for example, strongly inclined screen surfaces or free-form surfaces. In addition to the multi-channel arrangement, the basis for this is the utilization of the hyperfocality of each individual channel, resulting from the comparatively small optical aperture expansions (0.5 mm . . . 10 mm) compared to the usual projection distances (10 cm . . . 10 m).

The application of the algorithms for object structure generation described in DE 102013208625 A1 can result in an extended depth of field compared to single-channel projection systems with the same luminous flux. In special cases, the calculation rules disclosed in DE 102013208625 A1 can also be used to generate more than one projection image within the 3-dimensional projection light field without the need to readjust the object information formed on the surface light modulators D_{i,j}.

Using surface light modulators D_{i,j} with a pixel brightness depth (number of grey values) that can be controlled by 8-bit pulse width modulation, for example, results in a displayable bit depth (number of displayable grey scales of an image pixel) of i·j=N channels in the overall image 3 results in a displayable bit depth (number of displayable grey levels) of an image pixel of 256×N. This corresponds to an increase in the displayable grey values or image depth due to the multi-channel superposition projection principle.

The exemplary embodiment, shown in FIG. 9 and FIG. 16, allows the optical elements to be used as a monolithic component to encapsulate the surface light emitter and replaces the cover plate required for conventional projectors.

In a further special embodiment of the solution according to the invention, it is proposed that within the assembly 2, a subset of projection channels K_{i,j} with the same column index j are assigned channel-specific color filters with the same transmission spectrum, for example red, green or blue, and the corresponding surface light modulators D_{i,j} display the corresponding color component as ON pixels, resulting in a full-color overall image on the screen 3 by superimposing all channels K_{i,j} colored in the primary colors.

The use of the arrangement described in DE 102012205165 B4 and DE 2013206604 A1 in combination with the arrangement according to the invention disclosed here enables the projection of virtual image content, for example in the form of near-eye data vision goggles or an arrangement for reflecting information into the field of view of a vehicle occupant.

The aspect ratio of commercially available DMD surface light modulators is often 16:9; the use of optical elements with apertures of which the format also corresponds to 16:9 or 1:1 is advantageous for the realization of an efficient projection system due to the resulting optimum area utilization of the surface light modulators in combination with the usual spatial distributions of available light sources (high-power LEDs, laser diodes).

One way of further increasing the system efficiency of the arrangement referred to in claim 1 is to feed light, which strikes the tilting mirror pixels of the surface light modulators in the OFF state and leaves the assembly of the optical elements unimaged again after reflection at the surface light modulator without being able to strike the screen a second or further times, into the illumination beam path with the aid of further optical components, so that it can pass through the illumination beam path further times and thus possibly strike ON pixels during a further pass and can be imaged in the direction of the screen.

1: Projection display, with at least one light source (1), characterized in that it comprises at least one assembly (2),
which consists of at least two optical individual channels (K),
which are each formed of
in each case a surface light modulator (D) influencing the light propagation direction pixel by pixel, and an optical element (O),
and in that, for all channels of the assembly,
the cross-channel totality of optical elements of all channels illuminates the surface light modulator (D) when light enters the assembly (2), in such a way that the optical element (O) of this channel images the light reflected at the surface light modulator (D) as an object structure and all images of the individual channels are superimposed to form one or more virtual or real overall images on a screen (3).

2: Projection display according to claim 1, characterized in that an assembly (2)
consisting of individual optical channels K_{i,j},
is formed in a two-dimensional i×j matrix, lying in the x-y plane, with o≥3 and jₘₐₓ≥1, consisting of individual optical channels as matrix elements (K_{i,j}) thereof,
in each case defined by:
$$\begin{matrix}{K}_{i , j} = ( {D}_{i , j} , {O}_{i , j} ) with i , j ∈ ℕ and j ∈ \{ 1 , … , {j}_{max} \} and i ∈ \{ 1 , … , d \} \\ {K}_{i , j} = ( {O}_{i , j} ) with i , j ∈ ℕ and j ∈ \{ 1 , … , {j}_{max} \} and i ∈ ( d + 1 , … , o ) and o \geq d + 1\end{matrix}$$
with an area light modulator (D_{i,j}), which can address the light propagation direction pixel by pixel by reflection or combination of reflection and diffraction and of which the normal vector of light incidence and light emission vectors runs parallel to the y-axis, arranged in d rows with d≥2 and jₘₐₓ columns, and an optical element (O_{i,j}) arranged in o rows and jₘₐₓ columns,
wherein the respective individual optical channel (K_{i,j}) is formed in such a way, that when light enters the assembly (2), the surface light modulators (D_{i,j}) of the individual channel (K_{i,j}) of the i-th row and the j-th column are illuminated by a subset of the optical elements (O_{i,j}) that are defined by the illumination assignment function b(i,j) according to
$$b ( i , j ) ⊂ \{ {O}_{i , j} , {O}_{( i + 1 ) , j} , {O}_{( i + 2 ) , j} \} with b ( i , j ) \neq \{ {O}_{i , j} \} and b ( i , j ) \neq ∅$$
and, respectively,
$$b ( i , j ) = \{ \{ {O}_{i , j} , {O}_{( i + 1 ) , j} \} , \{ {O}_{i , j} , {O}_{( i + 2 ) , j} \} , \{ {O}_{i , j} , {O}_{( i + 1 ) , j} , {O}_{( i + 2 ) , j} \} , \{ {O}_{( i + 1 ) , j} \} , \{ {O}_{( i + 1 ) j} , {O}_{( i + 2 ) , j} \} , \{ {O}_{( i + 2 ) , j} \} \}$$
with a counting method for i in which the (i+1)-th channel row is always positioned between the i-th channel row and the light source,
so that, after reflection, at the surface light modulator (D_{i,j}) of the i-th row and j-th column, each of the (D_{i,j}) is optically imaged by the set of optical elements (O_{i,j}) of the i-th row and j-th column defined by the projection mapping function p(i,j) according to
$$p ( i , j ) = \{ {O}_{i , j} \}$$
and all individual projection images of the assembly (2) are superimposed to form one or more virtual or real overall images on a screen 3.

3: Projection display according to claim 1 or 2, characterized in that the illumination beam path (17) of all individual paths is deflected at a reflector (19) arranged between the light source (1) and the assembly (2).

4: Projection display according to claim 1 or 2, characterized in that the illumination beam path (13) and the projection beam path (14) are spatially separated by total reflection within a prism (10), which is arranged between light source (1) and assembly (2), so that either the illumination beam path (13) is totally reflected and the projection beam path (14) is transmitted in the direction of the screen (3) or the illumination beam path (13) is transmitted in the direction of the composite (2) and the projection beam path (14) is totally reflected in the direction of the screen (3).

5: Projection display according to claim 1 or 2, characterized in that
an overall lens with a variably adjustable focal length (5) is arranged between the assembly (2) and screen (3), by means of which overall lens the optical axes of the individual image projections are aligned according to their set focal length, and thus a variable image synthesis can be realized for example in the overall image with maximum illumination, minimum number of pixels and minimum image size or an overall image with minimum illumination, maximum number of pixels and maximum image size.

6: Projection display according to claim 1 or 2, characterized in that
within the assembly (2), projection channels (K_{i,j}) with the same j-index are assigned color filters with the same transmission spectrum, for example red, green or blue, and the corresponding surface light modulators (D_{i,j}) display the corresponding color component as ON pixels, resulting in a full-color overall image on the screen (3) by superimposing all channels (K_{i,j}) colored in the primary colors.

7: Projection display according to claim 1 or 2, characterized in that a subset of all projection channels (K_{i,j}) is formed in such a way that the corresponding overall projection image thereof has a spatial offset in the plane of the screen relative to the projected overall image of a further subset of projection channels, which offset corresponds to a fraction of the pixel center-to-center distance of the projected surface light modulator pixels and, by channel-individual modulation of the pixel information of all surface light modulators, the superimposition of all projections produces an integral overall image with an effectively displayable number of pixels which is higher than the displayable number of pixels of an individual projection image.
